(19) United States
(12) Patent Application Publication
(10) Pub. No.: US 2020/0245647 A1
(43) Pub. Date: Aug. 6, 2020

(54) SPARKLING NON-ALCOHOLIC BEVERAGE

(71) Applicants: Robert W. Kalis, Mesa, AZ (US); Amy G. Kalis, Mesa, AZ (US)

(72) Inventors: Robert W. Kalis, Mesa, AZ (US); Amy G. Kalis, Mesa, AZ (US)

(21) Appl. No.: 16/269,558

(22) Filed: Feb. 6, 2019

(51) Int. Cl. A23L 2/56; A23L 2/54; A23L 2/60; A23L 2/40

(52) U.S. Cl. CPC A23L 2/56; A23L 2/54; A23L 2/60; A23L 2/40; A23V 2250/21; A23V 2200/06; A23V 2200/15; A23V 2250/032; A23V 2250/11; A23V 2002/00

(57) ABSTRACT

The non-alcoholic beverage described in this invention uses minimally flavored hops as the biter ingredient. Specifically the alpha acids or humulone (α-lupulic acid) that is specifically extracted using an Isomerize CO2 Extract process, Isomerize is an extract of a treated extract, that keeps the bitterness of the hop while significantly reducing out the hop aroma (<0.1%). This has a significant improvement over prior art in that the flavor/aroma intensity of the hop, or source of the alpha acid, will not increase when a different bitter level is desired and the upper level is not restricted, meaning, higher IBU bitterness ratings are achievable (where 1 IBU equals 1 mg/l or 1 ppm of iso-alpha acids in solution in the beverage).

### BACKGROUND—FIELD OF INVENTION

Current mixer product, generically known as tonic water, and use quinine as the bitter ingredient. Historically, quinine, which is found in the bark of a cinchona tree, was used to combat malaria. The bitter taste of the quinine was controlled by mixing with other ingredients to make the administration of the medicine more palatable. Over time, the quinine was reduced to a non medicinal level (nonmedical use of quinine is limited to between 83 and 85 ppm) and used as the primary biter ingredient in what is today know a tonic water. The fact that quinine is a medication limits the bitterness that quinine can offer by limiting the quantity that is safe to consume.

Commonly accepted measurement of bitterness uses the International Bitterness Unit (IBU) scale which is a measure of the concentration where 1 IBU equals 1 mg/l or 1 ppm of iso-alpha acids in solution in the beverage. The human threshold for IBU is about typically 85-110 where value above may not be detectable but can be differ widely from person to person and may be desirable for other marketing reasons.

Iso-alpha acids are found in hops and are currently brewed into beers specifically known as India Pale Ale (IPA). Iso-alpha acids give the beer the bitter sensation and the other ingredients of the hop provides flavoring. There are many varieties of hops available which gives each beer its distinct flavor. Each hop can vary in Iso-Alpha acid levels from crop to crop. For beer, the IBU are determined using calculations during brewing. Other means to obtain the alpha acid have been used, such as tinctures but all these method have the undesirable result of adding the aromatic parts of the hops to the flavoring which is a undesirable effect for this invention. A tincture is a concentrated liquid herbal extract. It is typically made by soaking herbs and other plant parts in alcohol for weeks to extract the active constituents. Therefore, a tincture would not be acceptable to the embodiment of this invention in that it would add components of the hop that would alter the flavor. In addition, to increase the alpha acid, or bitterness, using a tincture would also increase the undesirable aroma and flavor intensity. This invention minimizes these undesirable results.

### BACKGROUND—PRIOR ART

The following is a tabulation of some prior art that presently appears relevant

U.S. Patents

| Patent Number | Kind Code | Issue Date | Patentee |
|---|---|---|---|
| 10,143,213 | 1/1 | Dec. 4, 2018 | Takatsu; Hideyuki |
| 10,117,451 | 1/1 | Nov. 6, 2018 | Yoshimura |
| 10,011,810 | 1/1 | Jul. 3, 2018 | Matsui |
| 9,314,048 | 1/1 | Apr. 19, 2016 | Roy |
| 8,778,418 | 424/725 | Jul. 15, 2014 | Bisterfeld Von Meer |
| 7,302,974 | 141/9 | Dec. 4, 2007 | Oono |
| 7,144,592 | 426/29 | Dec. 5, 2006 | Rader; Sydney R. |
| 6,039,987 | 426/74 | Mar. 21, 2000 | Strahl; Robert Charles |
| 5,405,624 | 426/11 | Apr. 11, 1995 | Doncheck |
| 4,133,903 | 426/590 | Jan. 9, 1979 | Thiele; Kurt |

U.S. Patents Applications

| Patent Number | Kind Code | Issue Date | Patentee |
|---|---|---|---|
| 20180153192 | 1/1 | Jun. 7, 2018 | YOSHIMURA |
| 20170020165 | 1/1 | Jan. 26, 2017 | Moore; Anthony Sean |
| 20140272006 | 426/87 | Sep. 18, 2014 | Schuh; Christian |
| 20140255585 | 426/598 | Sep. 11, 2014 | Joshi; Ketan |

### BACKGROUND—DESCRIPTION OF PRIOR ART

U.S. Pat App. No 20170020165 Moore describes an beverage using alcohol based tinctures for the hops. This type of hop extract has the disadvantage of maintaining the flavor and aroma of the particular hop making the beverage resemble a beer. Moore also refers to a CO2 Extract process, but this will also maintain the flavor and aroma of the particular hop. In addition, the alpha acids change per crop per season making the bitterness level needing adjustments per batch. The patent submitted uses a hop extracted using an Isomerize CO2 Extract process, which is an extract of a treated extract, that keeps the bitterness of the hop while significantly reducing out the hop aroma (<0.1%). It also greatly reduces the dependency on the hop per season and per crop. This process is critical to make the product not taste like a beer or the hop. It is also critical in order to selectively change the bitterness, with higher IBU limit being possible in order to meet the consumers taste without saturating the product with a particular aroma or taste that happens with the current prior art.

U.S. Pat. No. 10,143,213 Takatsu, U.S. Pat App. No 20140255585 Joshi, describes a beverage with, among other ingredient, alpha acids. Takatsu relates to a many non-polymer catechin-containing packaged beverage that is used to improve storage life. Both Joshi and Takatsu also recognizes the bitterness when using such ingredients as an unpleasant side effect.

U.S. Pat. No. 10,117,451 Yoshimura, U.S. Pat. No. 5,405,624 Doncheck, U.S. Pat. No. 7,302,974 Oono, U.S. Pat. No. 10,011,810 Matsui, U.S. Pat App. No. 20180153192 YOSHIMURA, U.S. Pat App. No 20140272006 Schuh describe drinks that simulate a beer taste using hopes. This again teaches away from the current invention by using the flavors of the hops as part of the beverage.

U.S. Pat. No. 4,133,903 Thiele; Kurt describes a non quinine bitter beverage which comprises an aqueous solution containing cynaropicrin a known ingredient of certain plant species of the genus Cynara, namely the artichoke (Cynara scolymus L.) and the cardoon (C. cardunculus L.). This teaches away in the current invention by using Potassium salts of isohumulones as the bitter ingredient. Thiele is also describing a single ingredient not intended to be consume by itself but as part of a drink mixture.

U.S. Pat. No. 8,778,418 Bisterfeld Von Meer describes a hemp plant juice for the production of beverages. This invention, though it does mention bitter parts of the hemp plant, is more concerned with the extraction from the hemp plant. The invention is, again, used as an enhancer to drinks to be consumed which would be labeled as Cannabis drink. This invention teaches away from the bitter nature of the product and promotes other “benefits” to the consumption of cannabis. The invention also suffers from a social barrier to consumer in that cannabis may not be socially, or legally, accepted.

U.S. Pat. No. 7,144,592 Rader; Sydney R. describes a method of making a fully hop flavored beverage that employs a hop flavoring agent comprising an extract of hop solids. This patent also teaches away from the current invention by using the flavor of the hops as part of the flavoring. Since the current invention is intended to be used with distilled spirits like gin, who each used specific flavorings and botanical to distinguish their product from one another, this product intentional is not using flavors from the hops so as not to alter the flavoring of these spirits.

U.S. Pat. No. 9,314,048 Roy, is similar to any tonic water using quinine but replaces the quinine root source with a gentian root. It is therefore would have the same deficiency as quinine to control the bitterness, but having an upper limit to safely consume, and has the same undesirable effect as adding flavor of the root.

### SUMMARY, RAMIFICATIONS, AND SCOPE

The non-alcoholic carbonated beverage described in this invention has the advantage over prior or existing designs in that it adds a specialized alpha acids or humulone (α-lupulic acid) that is specifically extracted using an Isomerized CO2 Extract process, which is an extract of a treated extract, that keeps the bitterness (alpha acids) of the hop while significantly reducing out the hop aroma and flavoring (<0.1%). This type of extraction has a more pure biter agent that is critical to this invention in that is allows the bitterness levels to be controlled while isolating it from, and greatly minimizing, the unfavorable effects of adding additional flavoring or aromatics of the hops to the beverage. In addition, the bitterness levels can be increased to much higher levels than the prior art because the hop aroma is greatly minimized.

### BRIEF DESCRIPTION OF THE INVENTION

The invention relates to a non-alcoholic carbonated beverage that can be consumed alone but can be used to mix with other products alcoholic or non-alcoholic to enhance the taste without effecting the aromatics and flavoring of the product it is added to. Its primary feature is using hops as the biter ingredient, specifically the alpha acids or humulone (α-lupulic acid) that is specifically extracted using a Isomerized CO2 extraction process that keeps the bitterness of the hop with leaving out the hop aroma. This process is critical to make the product not taste like a beer or hop and will also allow for a bitter intensity that can be controlled for different consumer.

A further object is to control the biter level for different consumer tastes without the undesirable effect of intensifying the hops aroma or flavor to the beverage herein described.

A further objective is the bitterness upper level can be much higher intensities than current processes.

A significant object of this invention is to improve a drink mixer that uses safe bitter ingredients while not adding addition flavoring that could significantly overpower or alter the taste of the spirit or beverage the invention is mixed with.

### DETAILED DESCRIPTION OF THE INVENTION

The invention described here, uses minimally flavored hops as the biter ingredient. Specifically the alpha acids or humulone (α-lupulic acid) that is specifically extracted using an Isomerize CO2 Extract process, Isomerize is an extract of a treated extract, that keeps the bitterness of the hop while significantly reducing out the hop aroma (<0.1%). This has a significant improvement over prior art in that the flavor/aroma intensity of the hop will not increase when a different bitter level is desired and the upper level is not restricted, meaning, higher IBU bitterness ratings are achievable (where 1 IBU equals 1 mg/l or 1 ppm of iso-alpha acids in a solution) with a theoretical maximum being 1000.

The said biter agent, along with water and carbonation (CO2), is the basis for the beverage. Organic acid such as citric and/or malic and/or ascorbic can also be used in quantities sufficient to maintain a pH of >2.8 and typically less than 5. This ingredient adds to the flavor and as a preservative. This beverage will also use a means for sweetening the beverage in ranges from about 1% to 25%. Said sweetener can be natural such as sugar, honey, agave or artificial such as saccharin etc. The ingredients in this invention will be toward those that make the product as all-natural as possible.

Another distinct flavor that is one part of one embodiment of this patent that adds sensation without flavor is capsaicin which is found in a variety of peppers including, but not limited to cayenne pepper and can be used as an optional secondary flavoring.

Secondary flavoring can be used to give the drink a distinct familiar flavor using individual or a combination of flavoring that may include, but are not limited to, lime, lemon, orange, ginger, cucumber, celery.

In addition to savory flavors, ingredients that are considered spicy hot from peppers, such as cayenne and/or vinegar flavoring (sufficient to maintain a pH of 2.5-4.5) may be used to interact with the biter agent to create new flavor sensations.

I claim:

1. The beverage drink comprising the following ingredients and in substantially in the following ranges:
a. Isomerized CO2 extracted alpha acids or Humulone (α-lupulic acid): 0.001% to 99%
b. Water to make 100%
c. Carbon dioxide: 1-5 volumes.

2. The beverage drink in claim 1 further comprising:
a. Citric acid: 0.13-2.8% (sufficient to obtain a pH of 2.3-5.5)
b. Sweetener:1% to 25%

3. The beverage drink in claim 2 where said sweetener is sugar

4. The beverage drink in claim 2 where said sweetener is artificial

5. The beverage drink in claim 2 further comprising a means for preserving to increase shelf life

6. The beverage drink in claim 2 further comprising citrus flavoring

7. The beverage drink in claim 2 further comprising ginger flavoring

8. The beverage drink in claim 11 further comprising capsaicin flavoring (found in cayenne peppers and other pepper like plants)

9. The beverage drink in claim 2 further comprising vinegar flavoring (sufficient to maintain a pH of 2.5-4.5)

10. The beverage drink in claim 5 where said preservative is pasteurized.

11. The beverage drink comprising the following ingredients and in substantially in the following ranges:
a. Isomerized CO2 extracted alpha acids or Humulone (α-lupulic acid): 0.001% to about 98%
b. Carbon dioxide: 1-5 volumes.
c. Organic Acid (citric and/or malic and/or ascorbic) (sufficient to maintain a pH of >2.8)
d. Sweetener:1% to 25%
e. Water to make 100%

12. The beverage drink in claim 11 where said sweetener is sugar

13. The beverage drink in claim 11 where said sweetener is artificial

14. The beverage drink in claim 11 further comprising a means for preserving to increase shelf life

15. The beverage drink in claim 11 further comprising citrus flavoring

16. The beverage drink in claim 11 further comprising ginger flavoring

17. The beverage drink in claim 11 further comprising Capsaicin flavoring (found in cayenne peppers and other pepper plants)

18. The beverage drink in claim 11 further comprising vinegar flavoring (sufficient to maintain a pH of 2.5-4.5)

19. The beverage drink in claim 14 where said preservative is pasteurized.

20. The beverage drink comprising the following ingredients:
a. Isomerized CO2 extracted alpha acids or Humulone (α-lupulic acid) (sufficient to maintain a pH>2.8)
b. Organic Acid (citric and/or malic and/or ascorbic) (sufficient to maintain a pH of >2.4)
c. Capsaicin
d. Sweetener (Artificial or natural)<50%
e. Water to make 100%
f. Carbon dioxide: 1-5 volumes.
